(19) United States
(12) Patent Application Publication
(10) Pub. No.: US 2022/0078875 A1
(43) Pub. Date: Mar. 10, 2022

(54) METHOD AND APPARATUS FOR TIMER CONTROL FOR RRC CONNECTION RESUME PROCEDURE IN A WIRELESS COMMUNICATION SYSTEM

(71) Applicant: ASUSTek Computer Inc., Taipei City (TW)

(72) Inventors: Meng-Hui Ou, Taipei City (TW); Yu-Hsuan Guo, Taipei City (TW)

(21) Appl. No.: 17/402,103

(22) Filed: Aug. 13, 2021

Related U.S. Application Data
(60) Provisional application No. 63/075,490, filed on Sep. 8, 2020.

(51) Int. Cl. H04W 76/25; H04W 74/08; H04W 76/27; H04W 76/30

(52) U.S. Cl. CPC H04W 76/25; H04W 76/30; H04W 76/27; H04W 74/0833

(57) ABSTRACT

Methods and apparatuses are provided for starting a timer, or one or more timers, upon initiation of a RRC connection resume procedure, wherein the timer is used to control duration of the RRC connection resume procedure. The timer used to control the duration of RRC connection resume procedure can be well managed, controlled, and configured in the case of small data transmission and possible subsequent data transmission. The timer can be stopped by the UE without receiving a RRC response message of a RRC Resume Request message. The timer can be restarted upon completion of a random access procedure. There can be multiple timers, e.g., two in certain embodiments, of varying values and/or lengths.

### CROSS-REFERENCE TO RELATED APPLICATIONS

The present application claims priority to and the benefit of U.S. Provisional Patent Application Ser. No. 63/075,490, filed Sep. 8, 2020, with the full disclosure of the referenced provisional application fully incorporated herein by reference.

### FIELD

This disclosure generally relates to wireless communication networks and, more particularly, to a method and apparatus for control of one or more timers for RRC connection resume procedures in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3^{rd} Generation Partnership Project (3GPP) standards organization. Accordingly, changes to the current body of 3GPP standard are currently being submitted and considered to evolve and finalize the 3GPP standard.

### SUMMARY

Methods and apparatuses are provided for starting a timer upon initiation of a RRC connection resume procedure, wherein the timer is used to control duration of the RRC connection resume procedure. The timer (e.g., T319) used to control the duration of RRC connection resume procedure can be well managed, controlled, and configured in the case of small data transmission and possible subsequent data transmission.

The timer can be stopped by the UE without receiving a RRC response message of a RRC Resume Request message. The timer can be restarted upon completion of a random access procedure during the RRC connection resume procedure. Further, the timer can be stopped upon reception of a RRC response message for the RRC connection resume procedure. There can be multiple timers, e.g., two in certain embodiments, and the timer values and/or lengths can be the same or different, the timers may start and/or stop at the same or different times, and like timer variations and configurations can be employed for use with the present invention.

In various embodiments, the UE is configured to start a timer upon initiation of a RRC connection resume procedure, stop the timer without receiving a RRC response message, wherein the UE stops the timer in response to reception of lower layer acknowledgement, to reception of an indication, to reception of an UL grant, to reception of a DL assignment, in response to start monitoring PDCCH, etc.

In various embodiments, the UE is configured to start a timer upon initiation of a RRC connection resume procedure, wherein the timer is used to control duration of the RRC connection resume procedure, restart the timer upon completion of a random access procedure during the RRC connection resume procedure, and stop the timer upon reception of a RRC response message for the RRC connection resume procedure.

In various embodiments, a configuration of the timer is included in dedicated signalling. The UE may apply the configuration from system information if the UE has not received the dedicated signalling. The dedicated signalling may be a RRC message. The UE may enter RRC_INACTIVE in response to reception of the dedicated signalling. Further, the UE can apply different values for the timer in the cases with small data transmission and in the cases without small data transmission. If the UE initiates a RRC connection resume procedure with small data transmission, and possible subsequent data transmission, a second or a third value of the timer can be applied.

In various embodiments, the timer can be jointly considered with one or more additional timers to provide multiple timers. More than one timer could be used to control the duration of the RRC connection resume procedure (and/or small data transmission and possibly subsequent data transmission). The timers may include a first timer and a second timer. The first timer may be the timer T319. The second timer may be the timer mentioned in the provided examples or embodiments. The second timer may be different from the timer T319. The first timer and the second timer may be configured with the same or different values. The first timer and the second timer may be started with the same or different lengths.

### BRIEF DESCRIPTION OF THE DRAWINGS

FIG. 1 is a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 5.3.13.1-1 from 3GPP TS 38.331 V16.1.0, illustrating successful RRC connection resume.

FIG. 6 is a reproduction of FIG. 5.3.13.1-2 from 3GPP TS 38.331 V16.1.0, illustrating successful RRC connection resume fallback to RRC connection establishment.

FIG. 7 is a reproduction of FIG. 5.3.13.1-3 from 3GPP TS 38.331 V16.1.0, illustrating successful RRC connection resume followed by network release.

FIG. 8 is a reproduction of FIG. 5.3.13.1-4 from 3GPP TS 38.331 V16.1.0, illustrating successful RRC connection resume followed by network suspend.

FIG. 9 is a reproduction of FIG. 5.3.13.1-5 from 3GPP TS 38.331 V16.1.0, illustrating RRC connection resume followed by network reject.

FIG. 10A is a reproduction of FIG. 9.2.6-1(a) from 3GPP TS 38.300 V16.1.0, illustrating a Random Access Procedure of CBRA with 4-step RA type.

FIG. 10B is a reproduction of FIG. 9.2.6-1(b) from 3GPP TS 38.300 V16.1.0, illustrating a Random Access Procedure of CBRA with 2-step RA type.

FIG. 10C is a reproduction of FIG. 9.2.6-1(c) from 3GPP TS 38.300 V16.1.0, illustrating a Random Access Procedure of CFRA with 4-step RA type.

FIG. 10D is a reproduction of FIG. 9.2.6-1(d) from 3GPP TS 38.300 V16.1.0, illustrating a Random Access Procedure of CFRA with 2-step RA type.

FIG. 11 is a diagram of small data transmission and subsequent data transmission in RRC_INACTIVE, in accordance with embodiments of the present invention.

FIG. 12 is a diagram of stopping the timer T319, in accordance with embodiments of the present invention.

FIG. 13 is a flow diagram of UE timer control, including starting and stopping conditions, in accordance with embodiments of the present invention.

FIG. 14 is a diagram of restarting the timer T319, in accordance with embodiments of the present invention.

FIG. 15 is a flow diagram of UE timer handling and restarting control, in accordance with embodiments of the present invention.

FIG. 16 is a first example of a first timer and a second timer configuration, in accordance with embodiments of the present invention.

FIG. 17 is a second example of a first timer and a second timer configuration, in accordance with embodiments of the present invention.

FIG. 18 is a third example of a first timer and a second timer configuration, in accordance with embodiments of the present invention.

FIG. 19 is a fourth example of a first timer and a second timer configuration, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

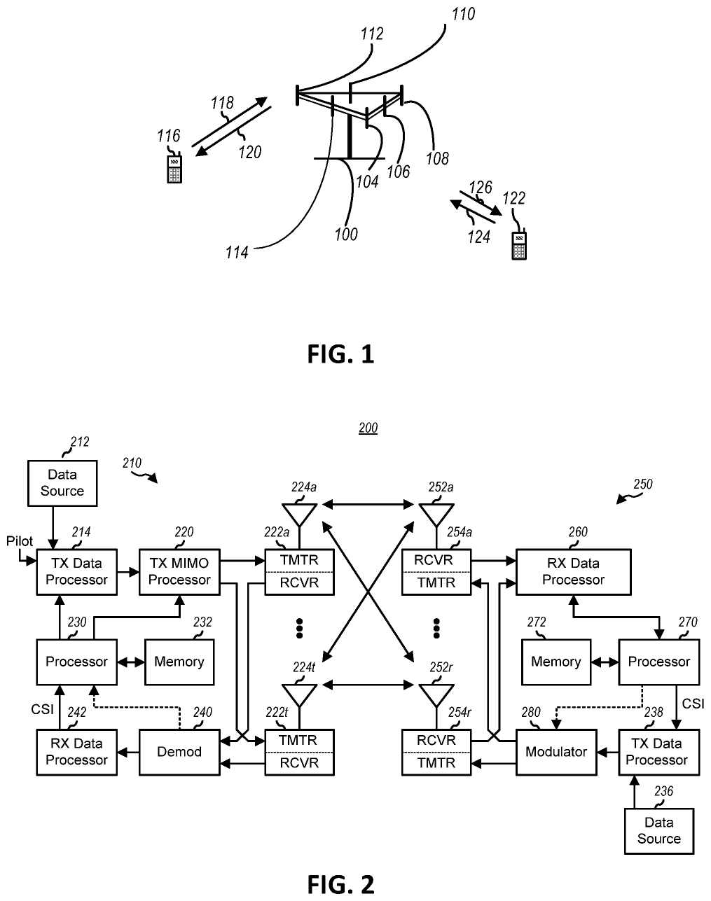

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

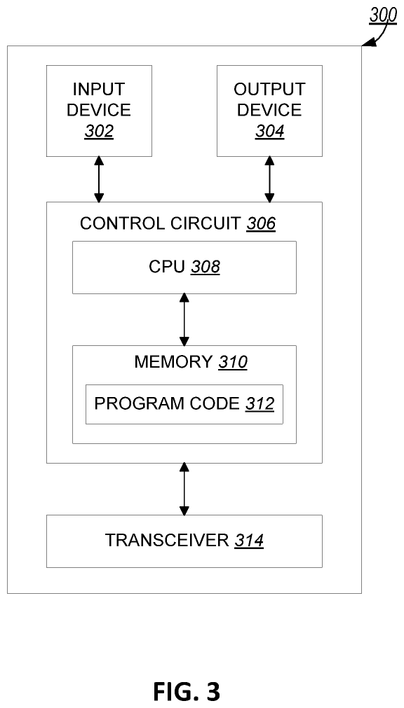

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

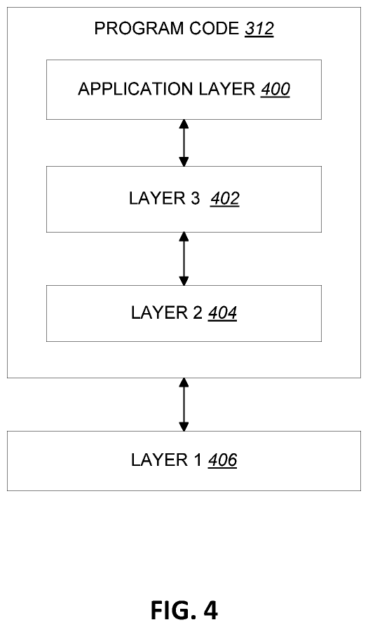

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention may be combined logically, reasonably, and properly to form a specific method.

Any sentence, paragraph, (sub-)bullet, point, action, or claim described in each of the following invention may be implemented independently and separately to form a specific method. Dependency, e.g., “based on”, “more specifically”, etc., in the following invention is just one possible embodiment which would not restrict the specific method.

The work item on NR small data transmission in INACTIVE state has been approved in RAN #86 (3GPP RP-193252):

### 4 Objective

This work item enables small data transmission in RRC_INACTIVE state as follows:
For the RRC_INACTIVE state:
   UL small data transmissions for RACH-based schemes (i.e. 2-step and 4-step RACH):
      General procedure to enable UP data transmission for small data packets from INACTIVE state (e.g., using MSGA or MSG3) [RAN2]
      Enable flexible payload sizes larger than the Rel-16 CCCH message size that is possible currently for INACTIVE state for MSGA and MSG3 to support UP data transmission in UL (actual payload size can be up to network configuration) [RAN2]
      Context fetch and data forwarding (with and without anchor relocation) in INACTIVE state for RACH-based solutions [RAN2, RAN3]
   Note 1: The security aspects of the above solutions should be checked with SA3
   Transmission of UL data on pre-configured PUSCH resources (i.e. reusing the configured grant type 1)—when TA is valid
      General procedure for small data transmission over configured grant type 1 resources from INACTIVE state [RAN2]
      Configuration of the configured grant type1 resources for small data transmission in UL for INACTIVE state [RAN2]
         In NR, RRC connection resume procedure is used for the UE in RRC_INACTIVE to resume a RRC connection. See 3GPP TS 38.331 V16.1.0.

### 5.3.13 RRC Connection Resume

### 5.3.13.1 General

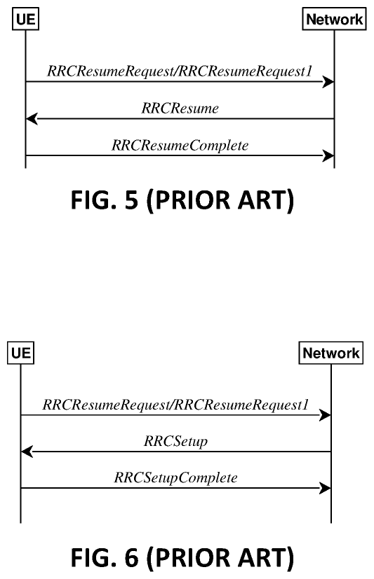

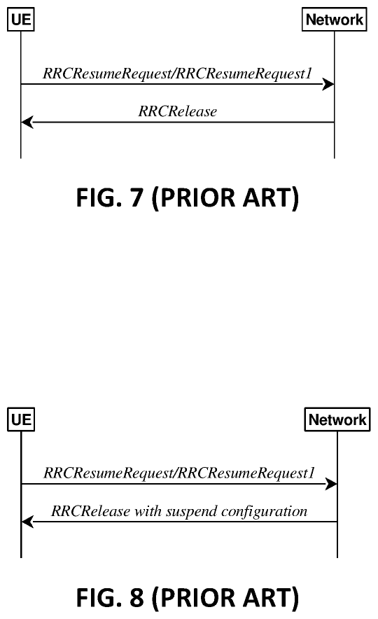

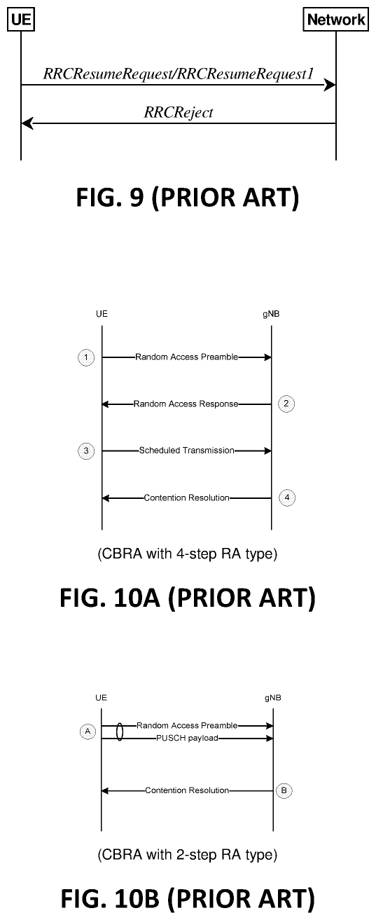

FIG. 5 is a reproduction of FIG. 5.3.13.1-1 from 3GPP TS 38.331 V16.1.0: RRC connection resume, successful.
FIG. 6 is a reproduction of FIG. 5.3.13.1-2 from 3GPP TS 38.331 V16.1.0: RRC connection resume fallback to RRC connection establishment, successful.
FIG. 7 is a reproduction of FIG. 5.3.13.1-3 from 3GPP TS 38.331 V16.1.0: RRC connection resume followed by network release, successful.
FIG. 8 is a reproduction of FIG. 5.3.13.1-4 from 3GPP TS 38.331 V16.1.0: RRC connection resume followed by network suspend, successful.
FIG. 9 is a reproduction of FIG. 5.3.13.1-5 from 3GPP TS 38.331 V16.1.0: RRC connection resume, network reject.
The purpose of this procedure is to resume a suspended RRC connection, including resuming SRB(s) and DRB(s) or perform an RNA update.

. . .

### 5.3.13.2 Initiation

The UE initiates the procedure when upper layers or AS (when responding to RAN paging, upon triggering RNA updates while the UE is in RRC_INACTIVE, or for sidelink communication as specified in sub-clause 5.3.13.1a) requests the resume of a suspended RRC connection.
The UE shall ensure having valid and up to date essential system information as specified in clause 5.2.2.2 before initiating this procedure.
Upon initiation of the procedure, the UE shall:
[ . . . ]
1> apply the default L1 parameter values as specified in corresponding physical layer specifications, except for the parameters for which values are provided in SIB1;
1> apply the default SRB1 configuration as specified in 9.2.1;
1> apply the default MAC Cell Group configuration as specified in 9.2.2;
1> release delayBudgetReportingConfig from the UE Inactive AS context, if stored;
1> stop timer T342, if running;
1> release overheatingAssistanceConfig from the UE Inactive AS context, if stored;
1> stop timer T345, if running;
1> release idc-AssistanceConfig from the UE Inactive AS context, if stored;

1> release drx-PreferenceConfig for all configured cell groups from the UE Inactive AS context, if stored; 1> stop all instances of timer T346a, if running;
1> release maxBW-PreferenceConfig for all configured cell groups from the UE Inactive AS context, if stored;
1> stop all instances of timer T346b, if running;
1> release maxCC-PreferenceConfig for all configured cell groups from the UE Inactive AS context, if stored;
1> stop all instances of timer T346c, if running;
1> release maxMIMO-LayerPreferenceConfig for all configured cell groups from the UE Inactive AS context, if stored;
1> stop all instances of timer T346d, if running;
1> release minSchedulingOffsetPreferenceConfig for all configured cell groups from the UE Inactive AS context, if stored;
1> stop all instances of timer T346e, if running;
1> release releasePreferenceConfig from the UE Inactive AS context, if stored;
1> stop timer T346f, if running;
1> apply the CCCH configuration as specified in 9.1.1.2;
1> apply the timeAlignmentTimerCommon included in SIB1;
1> start timer T319;
1> set the variable pendingRNA-Update to false;
1> initiate transmission of the RRCResumeRequest message or RRCResumeRequest1 in accordance with 5.3.13.3.

### 5.3.13.3 Actions Related to Transmission of RRCResumeRequest or RRCResumeRequest1 Message

The UE shall set the contents of RRCResumeRequest or RRCResumeRequest1 message as follows:

[ . . . ]

1> re-establish PDCP entities for SRB1;

1> resume SRB1;

1> submit the selected message RRCResumeRequest or RRCResumeRequest1 for transmission to lower layers.

NOTE 2: Only DRBs with previously configured UP ciphering shall resume ciphering.

If lower layers indicate an integrity check failure while T319 is running, perform actions specified in 5.3.13.5.
The UE shall continue cell re-selection related measurements as well as cell re-selection evaluation. If the conditions for cell re-selection are fulfilled, the UE shall perform cell re-selection as specified in 5.3.13.6.

### 5.3.13.4 Reception of the RRCResume by the UE

The UE shall:
1> stop timer T319;
1> stop timer T380, if running;
1> if T331 is running:
   2> stop timer T331;
   2> perform the actions as specified in 5.7.8.3;
1> if the RRCResume includes the fullConfig:
   2> perform the full configuration procedure as specified in 5.3.5.11;
1> else:
   2> if the RRCResume does not include the restoreMCG-SCells:
      3> release the MCG SCell(s) from the UE Inactive AS context, if stored;
   2> if the RRCResume does not include the restoreSCG:
      3> release the MR-DC related configurations (i.e., as specified in 5.3.5.10) from the UE Inactive AS context, if stored;
   2> restore the masterCellGroup, mrdc-SecondaryCellGroup, if stored, and pdcp-Config from the UE Inactive AS context;
   2> configure lower layers to consider the restored MCG and SCG SCell(s) (if any) to be in deactivated state;
1> discard the UE Inactive AS context;
1> release the suspendConfig except the ran-NottficationAreaInfo;
1> if the RRCResume includes the masterCellGroup:
   2> perform the cell group configuration for the received masterCellGroup according to 5.3.5.5;
1> if the RRCResume includes the mrdc-SecondaryCellGroup:
   2> if the received mrdc-SecondaryCellGroup is set to nr-SCG:
      3> perform the RRC reconfiguration according to 5.3.5.3 for the RRCReconfiguration message included in nr-SCG;
   2> if the received mrdc-SecondaryCellGroup is set to eutra-SCG:
      3> perform the RRC connection reconfiguration as specified in TS 36.331 [10], clause 5.3.5.3 for the RRCConnectionReconfiguration message included in eutra-SCG;
1> if the RRCResume includes the radioBearerConfig:
   2> perform the radio bearer configuration according to 5.3.5.6;
1> if the RRCResume message includes the sk-Counter:
   2> perform security key update procedure as specified in 5.3.5.7;
1> if the RRCResume message includes the radioBearerConfig2:
   2> perform the radio bearer configuration according to 5.3.5.6;
1> if the RRCResume message includes the needForGapsConfigNR:
   2> if needForGapsConfigNR is set to setup:
      3> consider itself to be configured to provide the measurement gap requirement information of NR target bands;
   2> else:
      3> consider itself not to be configured to provide the measurement gap requirement information of NR target bands;
1> resume SRB2, SRB3 (if configured), and all DRBs;
1> if stored, discard the cell reselection priority information provided by the cellReselectionPriorities or inherited from another RAT;
1> stop timer T320, if running;
1> if the RRCResume message includes the measConfig:
   2> perform the measurement configuration procedure as specified in 5.5.2;
1> resume measurements if suspended;
1> if T390 is running:
   2> stop timer T390 for all access categories;
   2> perform the actions as specified in 5.3.14.4;
1> if T302 is running:
   2> stop timer T302;
   2> perform the actions as specified in 5.3.14.4;
1> enter RRC_CONNECTED;
1> indicate to upper layers that the suspended RRC connection has been resumed;
1> stop the cell re-selection procedure;
1> consider the current cell to be the PCell;
[ . . . ]
1> submit the RRCResumeComplete message to lower layers for transmission;
1> the procedure ends.
   5.3.13.5 T319 Expiry or Integrity Check Failure from Lower Layers while T319 is Running
   The UE shall:
1> if timer T319 expires or upon receiving Integrity check failure indication from lower layers while T319 is running:
   2> if the UE has connection establishment failure information or connection resume failure information available in VarConnEstFailReport and if the RPLMN is not equal to plmn-identity stored in VarConnEstFailReport; or
   2> if the cell identity of current cell is not equal to the cell identity stored in measResultFailedCell in VarConnEstFailReport:
      3> reset the numberOfConnFail to 0;
   2> clear the content included in VarConnEstFailReport except for the numberOfConnFail, if any;
   2> store the following connection resume failure information in the VarConnEstFailReport by setting its fields as follows:
      3> set the plmn-Identity to the PLMN selected by upper layers (see TS 24.501 [23]) from the PLMN(s) included in the plmn-IdentityList in SIB1;
      3> set the measResultFailedCell to include the global cell identity, the cell level and SS/PBCH block level RSRP, and RSRQ, of the failed cell based on the available SSB measurements collected up to the moment the UE detected connection establishment failure;
      3> if available, set the measResultNeighCells, in order of decreasing ranking-criterion as used for cell re-selection, to include neighbouring cell measurements for at most the following number of neighbouring cells: 6 intra-frequency and 3 inter-frequency neighbours per frequency as well as 3 inter-RAT neighbours, per frequency/set of frequencies per RAT and according to the following:
         4> for each neighbour cell included, include the optional fields that are available;
NOTE: The UE includes the latest results of the available measurements as used for cell reselection evaluation, which are performed in accordance with the performance requirements as specified in TS 38.133 [14].
   3> if available, set the locationInfo as in 5.3.3.7;
   3> set perRAInfoList to indicate random access failure information as specified in 5.7.10.5;
   3> if numberOfConnFail is smaller than 8:
      4> increment the numberOfConnFail by 1;
   2> perform the actions upon going to RRC_IDLE as specified in 5.3.11 with release cause ‘RRC Resume failure’.
      The UE may discard the connection resume failure or connection establishment failure information, i.e. release the UE variable VarConnEsFailReport, 48 hours after the last connection resume failure is detected.
      5.3.13.6 Cell Re-Selection or Cell Selection while T390, T319 or T302 is Running (UE in RRC_INACTIVE)
      The UE shall:
1> if cell reselection occurs while T319 or T302 is running:
   2> perform the actions upon going to RRC_IDLE as specified in 5.3.11 with release cause ‘RRC Resume failure’;
1> else if cell selection or reselection occurs while T390 is running:
   2> stop T390 for all access categories;
   2> perform the actions as specified in 5.3.14.4.

### 5.3.13.7 Reception of the RRCSetup by the UE

The UE shall:
1> perform the RRC connection setup procedure as specified in 5.3.3.4.
. . .

### 5.3.13.9 Reception of the RRCRelease by the UE

The UE shall:
1> perform the actions as specified in 5.3.8.

### 5.3.13.10 Reception of the RRCReject by the UE

The UE shall:
1> perform the actions as specified in 5.3.15.
   5.3.13.11 Inability to Comply with RRCResume
   The UE shall:
1> if the UE is unable to comply with (part of) the configuration included in the RRCResume message;
   2> perform the actions upon going to RRC_IDLE as specified in 5.3.11 with release cause ‘RRC Resume failure’.
NOTE 1: The UE may apply above failure handling also in case the RRCResume message causes a protocol error for which the generic error handling as defined in 10 specifies that the UE shall ignore the message.
NOTE 2: If the UE is unable to comply with part of the configuration, it does not apply any part of the configuration, i.e. there is no partial success/failure.

### 5.3.13.12 Inter RAT Cell Reselection

Upon reselecting to an inter-RAT cell, the UE shall:
1> perform the actions upon going to RRC_IDLE as specified in 5.3.11, with release cause ‘other’.
   In addition, the configuration and the actions related to the timer T319 is quoted below. See 3GPP TS 38.331 V16.1.0:

### UE-TimersAndConstants Information Element

-- ASN1START
-- TAG-UE-TIMERSANDCONSTANTS-START

| | |
|---|---|
| UE-TimersAndConstants ::= | SEQUENCE { |

| | |
|---|---|
| t300 | ENUMERATED {ms100, ms200, ms300, ms400, ms600, ms1000, |

ms1500, ms2000},

| | |
|---|---|
| t301 | ENUMERATED {ms100, ms200, ms300, ms400, ms600, ms1000, |

ms1500, ms2000},

| | |
|---|---|
| t310 | ENUMERATED {ms0, ms50, ms100, ms200, ms500, ms1000, |

ms2000},

| | |
|---|---|
| n310 | ENUMERATED {n1, n2, n3, n4, n6, n8, n10, n20}, |
| t311 | ENUMERATED {ms1000, ms3000, ms5000, ms10000, ms15000, |

ms20000, ms30000},

| | |
|---|---|
| n311 | ENUMERATED {n1, n2, n3, n4, n5, n6, n8, n10}, |
| t319 | ENUMERATED {ms100, ms200, ms300, ms400, ms600, ms1000, |

ms1500, ms2000},

...

}
-- TAG-UE-TIMERSANDCONSTANTS-STOP
-- ASN1STOP
...

| Timer | Start | Stop | At expiry |
|---|---|---|---|
| T319 | Upon transmission of | Upon reception of | Perform the actions as |
| | RRCResumeRequest | RRCResume, RRCSetup, | specified in 5.3.13.5. |
| | or | RRCRelease, RRCRelease | |
| | RRCResumeRequest1 | with suspendConfig or | |
| | . | RRCReject message, cell re- | |
| | | selection and upon abortion | |
| | | of connection establishment | |
| | | by upper layers. | |

In RAN2 #111e meeting, the following agreement was reached (3GPP RAN2 #111e meeting minutes):

Agreements

| | |
|---|---|
| 1 | Small data transmission with RRC message is supported as baseline for RA-based and |
| | CG based schemes |
| 2 | RRC-less can be studied for limited use cases (e.g., same serving cell and/or for CG) |
| | with lower priority |
| 3 | Context fetch and data forwarding with anchor re-location and without anchor re- |
| | location will be considered. FFS if there are problems with the scenario “without |
| | anchor relocation”. |
| 4 | From RAN2 perspective, stored “configuration” in the UE Context is used for the RLC |
| | bearer configuration for any SDT mechanism (RACH and CG). |
| 5 | The 2-step RACH or 4-step RACH should be applied to RACH based uplink small data |
| | transmission in RRC_INACTIVE |
| 6 | The uplink small data can be sent in MSGA of 2-step RACH or msg3 of 4-step RACH. |
| 7 | Small data transmission is configured by the network on a per DRB basis |
| 8 | Data volume threshold is used for the UE to decide whether to do SDT or not. FFS |
| | how we calculate data volume. |
| | FFS if an “additional SDT specific” RSRP threshold is further used to determine |
| | whether the UE should do SDT |
| 9 | UL/DL transmission following UL SDT without transitioning to RRC_CONNECTED is |
| | supported |
| 10 | When UE is in RRC_INACTIVE, it should be possible to send multiple UL and DL |
| | packets as part of the same SDT mechanism and without transitioning to |
| | RRC_CONNECTED on dedicated grant. FFS on details and whether any indication to |
| | network is needed. |

General descriptions of random access procedure in NR is specified in TS 38.300 (3GPP TS 38.300 V16.1.0):

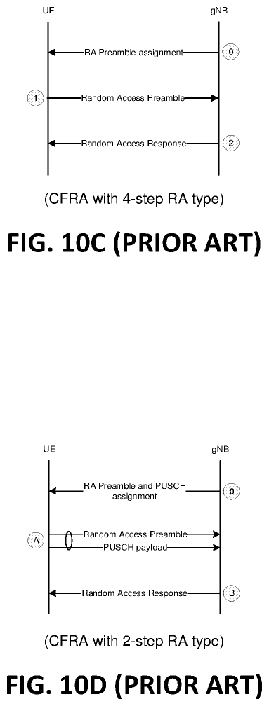

### 9.2.6 Random Access Procedure

[ . . . ]
Referring to FIGS. 10A-10D, two types of random access procedure are supported: 4-step RA type with MSG1 and 2-step RA type with MSGA. Both types of RA procedure support contention-based random access (CBRA) and contention-free random access (CFRA) as shown in FIGS. 9.2.6-1 from 3GPP TS 38.300 V16.1.0.
The UE selects the type of random access at initiation of the random access procedure based on network configuration:
when CFRA resources are not configured, an RSRP threshold is used by the UE to select between 2-step RA type and 4-step RA type;
when CFRA resources for 4-step RA type are configured, UE performs random access with 4-step RA type;
when CFRA resources for 2-step RA type are configured, UE performs random access with 2-step RA type.
   The network does not configure CFRA resources for 4-step and 2-step RA types at the same time for a Bandwidth Part (BWP). CFRA with 2-step RA type is only supported for handover.
   The MSGA of the 2-step RA type includes a preamble on PRACH and a payload on PUSCH. After MSGA transmission, the UE monitors for a response from the network within a configured window. For CFRA, upon receiving the network response, the UE ends the random access procedure, as shown in FIG. 10D. For CBRA, if contention resolution is successful upon receiving the network response, the UE ends the random access procedure as shown in FIG. 10B; while if fallback indication is received in MSGB, the UE performs MSG3 transmission and monitors contention resolution as shown in FIG. 9.2.6-2 from 3GPP TS 38.300 V16.1.0. If contention resolution is not successful after MSG3 (re)transmission(s), the UE goes back to MSGA transmission.
   If the random access procedure with 2-step RA type is not completed after a number of MSGA transmissions, the UE can be configured to switch to CBRA with 4-step RA type.
   For random access in a cell configured with SUL, the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.
   In addition, details of random access procedure in NR is specified in TS 38.321 (3GPP TS 38.321 V16.1.0):

### 5.1.4a MSGB Reception and Contention Resolution for 2-Step RA Type

Once the MSGA preamble is transmitted, regardless of the possible occurrence of a measurement gap, the MAC entity shall:
1> start the msgB-ResponseWindow at the PDCCH occasion as specified in TS 38.213 clause 8.2A (3GPP TS 38.300 V16.1.0);
1> monitor the PDCCH of the SpCell for a Random Access Response identified by MSGB-RNTI while the msgB-Response Window is running;
1> if C-RNTI MAC CE was included in the MSGA:
   2> monitor the PDCCH of the SpCell for Random Access Response identified by the C-RNTI while the msgB-Response Window is running.
1> if notification of a reception of a PDCCH transmission of the SpCell is received from lower layers:
   2> if the C-RNTI MAC CE was included in MSGA:
      3> if the Random Access procedure was initiated for SpCell beam failure recovery (as specified in clause 5.17) and the PDCCH transmission is addressed to the C-RNTI:
         4> consider this Random Access Response reception successful;
         4> stop the msgB-ResponseWindow;
         4> consider this Random Access procedure successfully completed.
      3> else if the timeAlignmentTimer associated with the PTAG is running:
         4> if the PDCCH transmission is addressed to the C-RNTI and contains a UL grant for a new transmission:
         5> consider this Random Access Response reception successful;
         5> stop the msgB-ResponseWindow;
         5> consider this Random Access procedure successfully completed.
      3> else:
         4> if a downlink assignment has been received on the PDCCH for the C-RNTI and the received TB is successfully decoded:
         5> if the MAC PDU contains the Absolute Timing Advance Command MAC CE subPDU:
         6> process the received Timing Advance Command (see clause 5.2);
         6> consider this Random Access Response reception successful;
         6> stop the msgB-ResponseWindow;
         6> consider this Random Access procedure successfully completed and finish the disassembly and demultiplexing of the MAC PDU.
   2> if a valid (as specified in TS 38.213, 3GPP TS 38.300 V16.1.0) downlink assignment has been received on the PDCCH for the MSGB-RNTI and the received TB is successfully decoded:
      3> if the MSGB contains a MAC subPDU with Backoff Indicator:
         4> set the PREAMBLE_BACKOFF to value of the BI field of the MAC subPDU using Table 7.2-1, multiplied with SCALING_FACTOR_BI.
      3> else:
         4> set the PREAMBLE_BACKOFF to 0 ms.
      3> if the MSGB contains a fallbackRAR MAC subPDU; and
      3> if the Random Access Preamble identifier in the MAC subPDU matches the transmitted PREAMBLE_INDEX (see clause 5.1.3a):
         4> consider this Random Access Response reception successful;
         4> apply the following actions for the SpCell:
         5> process the received Timing Advance Command (see clause 5.2);
         5> indicate the msgA-PreambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP);
         5> if the Random Access Preamble was not selected by the MAC entity among the contention-based Random Access Preamble(s):
         6> consider the Random Access procedure successfully completed;
         6> process the received UL grant value and indicate it to the lower layers.
         5> else:
         6> set the TEMPORARY C-RNTI to the value received in the Random Access Response;
         6> if the Msg3 buffer is empty:
         7> obtain the MAC PDU to transmit from the MSGA buffer and store it in the Msg3 buffer;
         6> process the received UL grant value and indicate it to the lower layers and proceed with Msg3 transmission.
NOTE: If within a 2-step RA type procedure, an uplink grant provided in the fallback RAR has a different size than the MSGA payload, the UE behavior is not defined.
   3> else if the MSGB contains a successRAR MAC subPDU; and
   3> if the CCCH SDU was included in the MSGA and the UE Contention Resolution Identity in the MAC subPDU matches the CCCH SDU:
      4> stop msgB-ResponseWindow;
      4> if this Random Access procedure was initiated for SI request:
         5> indicate the reception of an acknowledgement for SI request to upper layers.
      4> else:
         5> set the C-RNTI to the value received in the successRAR;
         5> apply the following actions for the SpCell:
         6> process the received Timing Advance Command (see clause 5.2);
         6> indicate the msgA-PreambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP).
      4> deliver the TPC, PUCCH resource Indicator, ChannelAccess-CPext (if indicated), and HARQ feedback Timing Indicator received in successRAR to lower layers.
      4> consider this Random Access Response reception successful;
      4> consider this Random Access procedure successfully completed;
      4> finish the disassembly and demultiplexing of the MAC PDU.

### 5.1.5 Contention Resolution

Once Msg3 is transmitted the MAC entity shall:
1> start the ra-ContentionResolutionTimer and restart the ra-ContentionResolutionTimer at each HARQ retransmission in the first symbol after the end of the Msg3 transmission;
1> monitor the PDCCH while the ra-ContentionResolutionTimer is running regardless of the possible occurrence of a measurement gap;
1> if notification of a reception of a PDCCH transmission of the SpCell is received from lower layers:
   2> if the C-RNTI MAC CE was included in Msg3:
      3> if the Random Access procedure was initiated for SpCell beam failure recovery (as specified in clause 5.17) and the PDCCH transmission is addressed to the C-RNTI; or
      3> if the Random Access procedure was initiated by a PDCCH order and the PDCCH transmission is addressed to the C-RNTI; or
      3> if the Random Access procedure was initiated by the MAC sublayer itself or by the RRC sublayer and the PDCCH transmission is addressed to the C-RNTI and contains a UL grant for a new transmission:
         4> consider this Contention Resolution successful;
         4> stop ra-ContentionResolutionTimer;
         4> discard the TEMPORARY_C-RNTI;
         4> consider this Random Access procedure successfully completed.
   2> else if the CCCH SDU was included in Msg3 and the PDCCH transmission is addressed to its TEMPORARY_C-RNTI:
      3> if the MAC PDU is successfully decoded:
         4> stop ra-ContentionResolutionTimer;
         4> if the MAC PDU contains a UE Contention Resolution Identity MAC CE; and
         4> if the UE Contention Resolution Identity in the MAC CE matches the CCCH SDU transmitted in Msg3:
         5> consider this Contention Resolution successful and finish the disassembly and demultiplexing of the MAC PDU;
         5> if this Random Access procedure was initiated for SI request:
         6> indicate the reception of an acknowledgement for SI request to upper layers.
         5> else:
         6> set the C-RNTI to the value of the TEMPORARY_C-RNTI;
         5> discard the TEMPORARY_C-RNTI;
         5> consider this Random Access procedure successfully completed.
         4> else:
         5> discard the TEMPORARY_C-RNTI;
         5> consider this Contention Resolution not successful and discard the successfully decoded MAC PDU.

### Timer T319

In NR, to control the duration of RRC Connection Resume procedure, timer T319 is used in Radio Resource Control (RRC). The timer T319 is started upon initiation of a RRC connection resume procedure. And the timer T319 is stopped upon reception of RRCRelease, RRCReconfiguration with reconfigurationwithSync for the Primary serving Cell (PCell), MobilityFromNRCornmand, or upon initiation of the RRC re-establishment procedure. Upon expiry of the timer T319, the UE enters RRC_IDLE and performs the related actions of entering RRC_IDLE, such as Medium Access Control (MAC) reset.

Under the work item of NR small data transmissions in INACTIVE state, UP data transmission in RRC_INACTIVE without entering RRC_CONNECTED is being studied. In the RAN2 #111e meeting, it was agreed that small data transmission with RRC message is supported as baseline. To perform the small data transmission in RRC_INACTIVE, it is likely that the UE initiates a RRC connection resume procedure and multiplexes the user data with the RRCResumeRequest (or RRCResumeRequest1) message.

The user data transmitted in RRC_INACTIVE (e.g., as mentioned above and herein) may be called “small data transmission” hereinafter. The small data transmission may be transmitted via a Random Access Channel (RACH)-based transmission (e.g., 2-step RA or 4-step RA, 3GPP TS 38.321 V16.1.0) and/or a Configure Grant (CG)-based transmission (e.g., preconfigured uplink resource, configured uplink grant). To differentiate from the subsequent data transmission mentioned below, the small data transmission may refer to the first user data transmission or the first transmission including user data.

Moreover, it was also agreed that Uplink (UL)/Downlink (DL) transmission following UL Small Data Transmission (SDT) without transitioning to RRC_CONNECTED is supported. The UL/DL transmission following UL SDT may be transmitted/received based on Network (NW) scheduling. The UL and/or DL transmission following UL SDT may be called “subsequent data transmission” hereinafter.

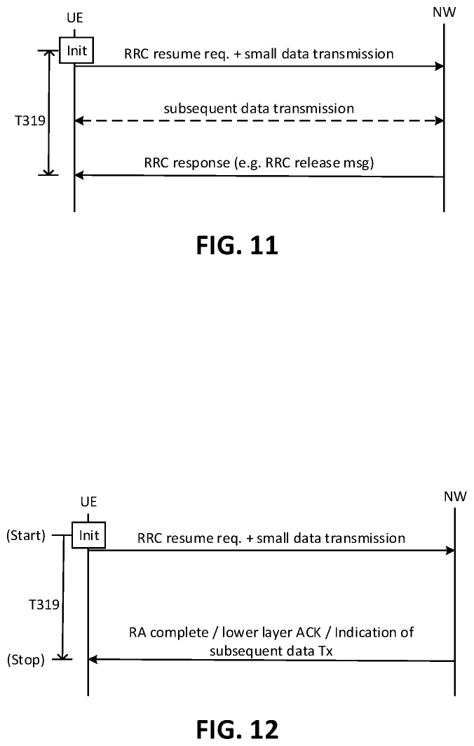

Referring to FIG. 11, to support subsequent data transmission in RRC_INACTIVE, it is possible that during a RRC connection resume procedure with small data transmission, network may delay (or postpone) the transmission of a RRC response message (e.g., RRCResume, RRCSetup, RRCRelease, etc.) to the RRCResumeRequest (or RRCResumeRequest1) message, in order to keep the UE in RRC_INACTIVE state and pending for NW scheduling of subsequent data transmission. And the RRC connection resume procedure may be kept ongoing for a long time (e.g., including the duration of small data transmission and subsequent data transmission). In this case, the possible value of the timer T319 may not be long enough (the current maximum value of T319 is 2000 ms), and the timer T319 may be expired before the subsequent data transmission is successfully completed. The expiry of the timer T319 could result in that the UE enters RRC_IDLE.

To cover the subsequent data transmission, it is proposed in 3GPP R2-2006582 that the value of the timer T319 should be extended. However, setting the timer T319 to a long value means that the UE may wait a long time before considering an ongoing RRC connection resume procedure as failed if no NW response is received. On the other hand, the duration of subsequent data transmission depends on NW scheduling and thus it may be quite varied. Moreover, the timer T319 is configured based on system information (SIB 1) broadcasted in the serving cell and thus it is a cell-specific configuration, while the extended value of the timer T319 may not be suitable for every UE in the serving cell (e.g., the UE without the need for small data transmission and/or subsequent data transmission).

To solve the issue, e.g., to avoid the expiry of the timer T319 during RRC connection resume procedure with small data transmission and possibly subsequent data transmission, the timer T319 needs to be well handled/controlled for the case of small data transmission, and possibly subsequent data transmission.

The details of the examples and embodiments described below and herein are not to be considered exclusive or restricted to application in a single example or embodiment and could be integrated or otherwise combined with other examples and embodiments, in whole or in part.

The timer T319 mentioned herein may represent a timer that is used to control the duration of RRC connection resume procedure (may be along with small data transmission) and/or to identify the failure of the RRC connection resume procedure (may be with SDT), e.g., how long the RRC connection resume procedure could last.

The systems, apparatuses, methods, examples, and embodiments described herein may be applicable to other timers/counters, or the timer/counter for similar usage, which may not be referred to as “T319.” The timer or counter may be started in response to or upon initiation of a RRC connection resume procedure (e.g., with small data transmission and/or subsequent data transmission) or in response to or upon transmission of a RRC resume request message (e.g., RRCResumeRequest, RRCResumeRequest1). The UE may enter RRC_IDLE in response to or upon expiry of the timer or counter.

### Timer Stop/Control

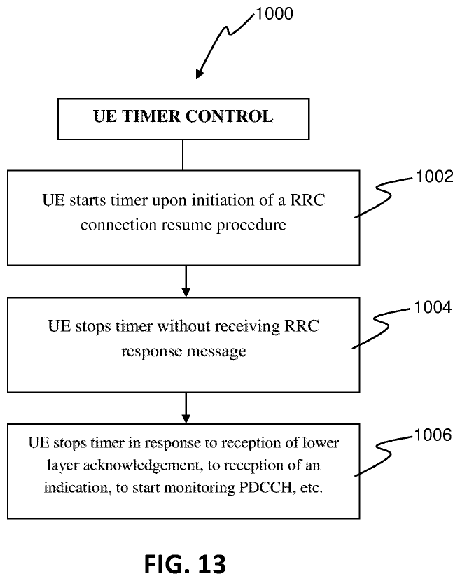

In the exemplary embodiment of FIGS. 12-13, the timer (e.g., T319) could be stopped by the UE without receiving a RRC response message of a RRC Resume Request (e.g., RRCResumeRequest, RRCResumeRequest1) message during a RRC connection resume procedure and without going to RRC_IDLE. The RRC response message may be a RRC Resume message, a RRC Setup message, a RRC Release message (e.g., with or without suspend configuration), or a RRC Reject message. See 3GPP TS 38.331 V16.1.0.

Referring to FIG. 13, a UE can be configured to perform the timer control steps 1000 of starting a timer upon initiation of a RRC connection resume procedure (step 1002), stopping the timer without receiving a RRC response message (step 1004), wherein the UE stops the timer in response to reception of lower layer acknowledgement, to reception of an indication, to reception of an UL grant, to reception of a DL assignment, in response to start monitoring PDCCH, etc (step 1006).

Referring back to FIGS. 3 and 4, in one or more embodiments, the device 300 includes a program code 312 stored in memory 310. The CPU 308 could execute program code 312 to (i) start a timer upon initiation of a RRC connection resume procedure; (ii) stop the timer without receiving a RRC response message, and (iii) wherein the UE stops the timer in response to reception of lower layer acknowledgement, to reception of an indication, to reception of an UL grant, to reception of a DL assignment, to start monitoring PDCCH, etc. Moreover, the CPU 308 can execute the program code 312 to perform all of the described actions, steps, and methods described herein.

For example, the timer (e.g., T319) may be stopped by the UE in response to successful completion of a random access procedure. The random access procedure may be used for small data transmission (e.g., RACH-based scheme). See 3GPP RP-193252.

The timer (e.g., T319) may be stopped by the UE upon the successful completion of the random access procedure, upon reception of Msg4 (e.g., contention resolution, 3GPP TS 38.321 V16.1.0), and/or upon reception of MSGB (3GPP TS 38.321 V16.1.0). The random access procedure may be 2-step RA, 4-step RA, contention based, and/or contention free.

For example, the timer (e.g., T319) may be stopped by the UE in response to reception of a lower layer acknowledgement. The lower layer acknowledgement may be associated with the Protocol Data Unit/Packet Data Unit (PDU) for small data transmission (e.g., the PDU including the first small data). The lower layer acknowledgement may be RLC acknowledgement, ARQ acknowledgement, and/or HARQ ACK (e.g., positive ACK). The timer (e.g., T319) may be stopped upon reception of the lower layer acknowledgement.

For example, the timer (e.g., T319) may be stopped by the UE in response to reception of an indication. The timer (e.g., T319) may be stopped upon reception of the indication. The indication may be used to indicate subsequent data transmission. The indication may be a UL grant (e.g., for subsequent data transmission) or DL assignment. The indication may be activation or configuration for subsequent data transmission (e.g., configured grant for subsequent data transmission).

The indication may be received from a network. The indication may be a RRC message. The indication may be a MAC signalling (e.g., MAC CE). The indication may be a PHY signalling (e.g., Physical Downlink Control Channel (PDCCH)).

The indication may be received from a lower layer. The lower layer may be Packet Data Convergence Protocol (PDCP), Radio Link Control (RLC), MAC, or HARQ.

For example, the timer (e.g., T319) may be stopped by the UE in response to reception of an UL grant. The UL grant may be a dynamic grant or a configured grant. The UL grant may be received after the small data transmission (e.g., the first UL grant after the small data transmission). The timer (e.g., T319) may be stopped upon reception of the UL grant.

For example, the timer (e.g., T319) may be stopped by the UE in response to reception of a DL assignment. The DL assignment may be received after the small data transmission (e.g., the first DL assignment after the small data transmission). The timer (e.g., T319) may be stopped upon reception of the DL assignment.

For example, the timer (e.g., T319) may be stopped by the UE in response to start monitoring PDCCH (e.g., addressed to Cell Radio Network Temporary Identifier (C-RNTI)). The PDCCH monitoring may be used for subsequent data transmission. The PDCCH monitoring may be started after the small data transmission. The timer (e.g., T319) may be stopped upon start monitoring PDCCH.

In another exemplary embodiment, if the timer (e.g., T319) is expired when the UE is performing, or is ready to perform, subsequent data transmission, at least one or more actions may be not performed.

The at least one or more actions may be performed by the UE upon timer (e.g., T319) expiry when the UE is not performing, or is not ready to perform, subsequent data transmission (e.g., during a RRC connection resume procedure without small data transmission).

The at least one or more actions may include: go to RRC_IDLE, reset MAC, discard the UE Inactive AS context, release the suspendConfig, discard Key(s), release radio resources, or indicate the release of a RRC connection to one or more upper layers.

The UE may perform, or be ready to perform, subsequent data transmission in response to or upon successful completion of a random access procedure (e.g., for small data transmission), in response to or upon reception of a lower layer acknowledgement (e.g., associated with the PDU for small data transmission), in response to or upon reception of an indication (e.g., the indication of subsequent data transmission), in response to or upon reception of a UL grant (e.g., for subsequent data transmimssion), in response to or upon reception of a DL assignment (e.g., for subsequent data transmission), and/or in response to or upon start monitoring PDCCH (e.g., for subsequent data transmission). More details or alternatives may be found in other examples or embodiments.

### Timer Restart/Control

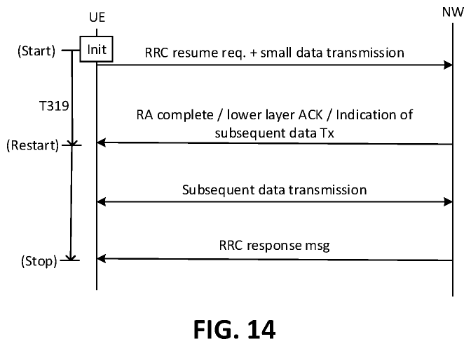

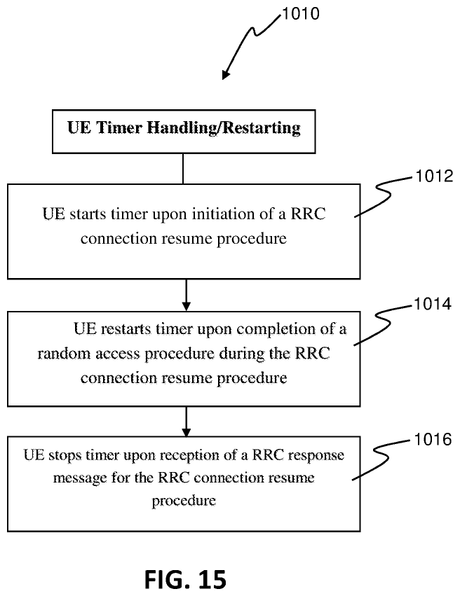

In another exemplary embodiment, as shown in FIGS. 14-15, the timer (e.g., T319) is restarted by the UE when the UE is ready to perform subsequent data transmission.

Referring to FIG. 15, a UE can be configured to perform the handling/restarting steps 1010 of starting a timer upon initiation of a RRC connection resume procedure (step 1012), wherein the timer is used to control the duration of the RRC connection resume procedure, restarting the timer upon completion of a random access procedure during the RRC connection resume procedure (step 1014), and stopping the timer upon reception of a RRC response message for the RRC connection resume procedure (step 1016).

In one exemplary embodiment, the RRC connection resume procedure is used for small data transmission.

In one exemplary embodiment, the UE goes to RRC_IDLE if the timer expires.

In one exemplary embodiment, the RRC response message is a RRC release message.

In one exemplary embodiment, the configuration of the timer is included in a dedicated signalling.

In one exemplary embodiment, the UE receives the RRC response message after the completion of the random access procedure.

In one exemplary embodiment, the UE transmits a RRC resume request message for the RRC connection resume procedure.

In one exemplary embodiment, the UE is in RRC_INACTIVE when performing the RRC connection resume procedure.

In one exemplary embodiment, the random access procedure is completed when the UE receives a MSGB containing a successRAR MAC subPDU, wherein a UE Contention Resolution Identity in the successRAR MAC subPDU matches a CCCH SDU included in a MSGA of the random access procedure.

In one exemplary embodiment, the random access procedure is completed when the UE receives a MAC PDU containing a UE Contention Resolution Identity MAC CE, wherein a UE Contention Resolution Identity in the UE Contention Resolution Identity MAC CE matches a CCCH SDU transmitted in Msg3 of the random access procedure.

Referring back to FIGS. 3 and 4, in one or more embodiments, the device 300 includes a program code 312 stored in memory 310. The CPU 308 could execute program code 312 to (i) start a timer upon initiation of a RRC connection resume procedure, wherein the timer is used to control the duration of the RRC connection resume procedure; (ii) restart the timer upon completion of a random access procedure during the RRC connection resume procedure; and (iii) stop the timer upon reception of a RRC response message for the RRC connection resume procedure. Moreover, the CPU 308 can execute the program code 312 to perform all of the described actions, steps, and methods described herein.

The timer (e.g., T319) may be restarted with a different value from the initial value of the timer (e.g., T319) (e.g., with a longer or shorter value).

The timer (e.g., T319) may be restarted or the UE may be ready to perform subsequent data transmission in response to or upon successful completion of a random access procedure (e.g., for small data transmission), in response to or upon reception of a lower layer acknowledgement (e.g., associated with the PDU for small data transmission), in response to or upon reception of an indication (e.g., the indication of subsequent data transmission), in response to or upon reception of a UL grant (e.g., for subsequent data transmission), in response to or upon reception of a DL assignment (e.g., for subsequent data transmission), and/or in response to or upon start monitoring PDCCH (e.g., for subsequent data transmission). More details or alternatives may be found in other examples or embodiments.

The timer (e.g., T319) may be stopped when the subsequent data transmission is completed or ended.

### Timer Configuration

In another exemplary embodiment, a configuration of the timer (e.g., T319) is included in dedicated signalling. The UE may apply the configuration from the dedicated signalling if the UE has received the dedicated signalling. The UE may apply the configuration from system information (e.g., SIB1) if the UE has not received the dedicated signalling.

The dedicated signalling may be a RRC message (e.g., RRC reconfiguration message, RRC release message, RRC release message with suspend indication, RRC resume message, RRC setup message, RRC reject message). The UE may enter RRC_INACTIVE in response to reception of the dedicated signalling.

The value provided in the dedicated signalling may be larger than the value broadcasted in the system information (e.g., SIB1).

In another exemplary embodiment, the UE applies different values for the timer (e.g., T319) in the case with small data transmission and in the case without small data transmission.

For example, if the UE initiates a RRC connection resume procedure without small data transmission, a first value of the timer (e.g., T319) is applied. If the UE initiates a RRC connection resume procedure with small data transmission, a second value of the timer (e.g., T319) is applied.

If the UE initiates a RRC connection resume procedure with small data transmission, and possible subsequent data transmission, a second, or a third value of the timer (e.g., T319) is applied.

The first value, the second value, and the third value may be different. The first value may be configured in system information (e.g., SIB 1). The second and/or the third value may be configured in dedicated signalling.

Other timer values and configurations and embodiments are envisioned for implementation herein without deviating from the spirit and scope of the present invention as understood by the those of ordinary skill in the art.

### Multiple Timers

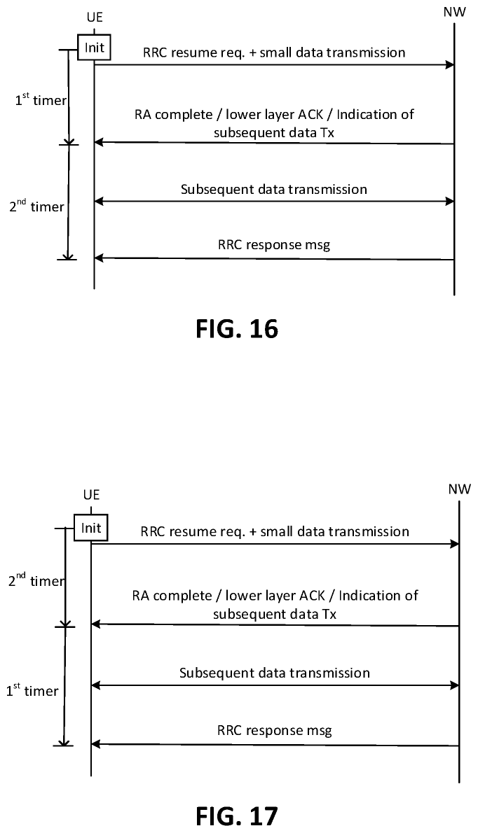

Referring to FIGS. 16-19, in various exemplary embodiments, the timer (e.g., T319) could be jointly considered with another timer (e.g., a timer different than T319)—e.g., comprising multiple timers. More than one timer could be used to control the duration of RRC connection resume procedure (and/or small data transmission and possibly subsequent data transmission). The timers may include a first timer and a second timer.

The first timer may be the timer mentioned in the provided examples or embodiments. The first timer may be the timer T319.

The second timer may be the timer mentioned in the provided examples or embodiments. The second timer may be different from the timer T319.

The first timer and the second timer may be configured with the same or different values. The first timer and the second timer may be started with the same or different lengths.

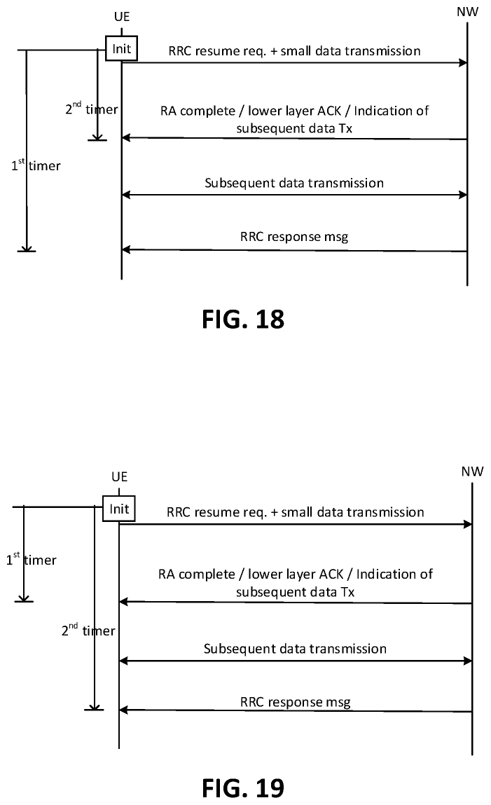

The second timer may be started by the UE in response to or upon the stopping of the first timer, as demonstrated in FIG. 16. Alternatively, the first timer may be started by the UE in response to or upon the stoppage of the second timer, as shown in FIG. 17. Alternatively, the first timer and the second timer may be started by the UE at the same time, as demonstrated in FIGS. 18-19.

The first timer and/or the second timer may be started by the UE in response to or upon initiation of a RRC connection resume procedure (e.g., with small data transmission and/or subsequent data transmission) or in response to or upon the transmission of a RRC resume request message (e.g., RRCResumeRequest, RRCResumeRequest1).

Alternatively or additionally, the first timer and/or the second timer may be started by the UE in response to or upon successful completion of a random access procedure (e.g., for small data transmission), in response to or upon reception of a lower layer acknowledgement (e.g., associated with the PDU for small data transmission), in response to or upon reception of an indication (e.g., the indication of subsequent data transmission), in response to or upon reception of a UL grant (e.g., for subsequent data transmission), in response to or upon reception of a DL assignment (e.g., for subsequent data transmission), and/or in response to or upon start monitoring PDCCH (e.g., for subsequent data transmission). More details or alternatives may be found in other examples or embodiments.

Referring again to FIGS. 18-19, the first timer and/or the second timer may be stopped by the UE in response to or upon the reception of a response message of a RRC resume request message (e.g., RRCResumeRequest, RRCResumeRequest1). The response message may be a RRC

Resume message, a RRC Setup message, a RRC Release message (e.g., with or without suspend configuration), or a RRC Reject message.

Alternatively or additionally, the first timer and/or the second timer may be stopped by the UE in response to or upon successful completion of a random access procedure (e.g., for small data transmission), in response to or upon reception of a lower layer acknowledgement (e.g., associated with the PDU for small data transmission), in response to or upon reception of an indication (e.g., the indication of subsequent data transmission), in response to or upon reception of a UL grant (e.g., for subsequent data transmission), in response to or upon reception of a DL assignment (e.g., for subsequent data transmission), and/or in response to or upon start monitoring PDCCH (e.g., for subsequent data transmission). More details or alternatives may be found in other examples or embodiments.

In response to or upon expiry of the first timer or the second timer, the UE may go to RRC_IDLE and/or perform at least one of the following actions: reset MAC, discard the UE Inactive AS context, release the suspendConfig, discard Key(s), release radio resources, indicate the release of a RRC connection to upper layer(s).

Additional timers and alternative timer configurations are envisioned for implementation herein without deviating from the spirit and scope of the present invention as understood by the those of ordinary skill in the art.

### Random Access Procedure Completion

The successful completion of the random access procedure may be when the UE receives a Msg4. The Msg4 could contain a MAC PDU containing a UE Contention Resolution Identity MAC CE, and a UE Contention Resolution Identity in the UE Contention Resolution Identity MAC CE matches a Common Control Channel (CCCH) Service Data Unit (SDU) transmitted in Msg3 of the random access procedure (e.g., for the random access procedure initiated by RRC resume procedure, for the case of 4-step RA). A PDCCH transmission to schedule the Msg4 and/or the MAC PDU could be received by the UE. The PDCCH transmission could be addressed to TEMPORARY_C-RNTI of the UE.

The successful completion of the random access procedure may be when the UE receives a MSGB. The MSGB could contain a successRAR (Random Access Response) MAC subPDU, and a UE Contention Resolution Identity in the successRAR MAC subPDU matches a CCCH SDU included in a MSGA of the random access procedure (e.g., for the random access procedure initiated by RRC resume procedure, for the case of 2-step RA). A PDCCH transmission to schedule the MSGB could be received by the UE. The PDCCH transmission could be addressed to MSGB-RNTI.

The UE may be in RRC_INACTIVE. The UE may not be in RRC_IDLE. The UE may not be in RRC_CONNECTED.

RRC_IDLE may be a RRC state where no RRC connection is established. RRC_CONNECTED may be a RRC state where a RRC connection is established. RRC_INACTIVE may be a RRC state where a RRC connection is suspended. The UE may store a UE inactive AS context in RRC_INACTIVE.

The UE may not change a serving cell during a RRC connection resume procedure. The UE may not change a serving cell during small data transmission and/or subsequent data transmission.

The network may be a network node. The network node may be NR Node B (gNB). The network node may control a serving cell of a UE. The serving cell may be a PCell. The serving cell may be a Secondary Cell (SCell). The network node may control a cell group of a UE. The cell group may be a Master Cell Group (MCG). The cell group may be a Secondary Cell Group (SCG).

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a User Equipment (UE), comprising:
starting a timer upon initiation of a Radio Resource Control (RRC) connection resume procedure, wherein the timer is used to control duration of the RRC connection resume procedure;
restarting the timer upon completion of a random access procedure during the RRC connection resume procedure; and
stopping the timer upon reception of a RRC response message for the RRC connection resume procedure.

2. The method of claim 1, wherein the RRC connection resume procedure is used for small data transmission.

3. The method of claim 1, wherein the UE goes to RRC_IDLE if the timer expires.

4. The method of claim 1, wherein the RRC response message is a RRC release message.

5. The method of claim 1, wherein a configuration of the timer is included in a dedicated signalling.

6. The method of claim 1, wherein the UE receives the RRC response message after the completion of the random access procedure.

7. The method of claim 1, wherein the UE transmits a RRC resume request message for the RRC connection resume procedure.

8. The method of claim 1, wherein the UE is in RRC_INACTIVE when performing the RRC connection resume procedure.

9. The method of claim 1, wherein the random access procedure is completed when the UE receives a MSGB containing a success Random Access Response (successRAR) Medium Access Control (MAC) subProtocol Data Unit (subPDU), wherein a UE Contention Resolution Identity (CRI) in the successRAR MAC subPDU matches a Common Control Channel (CCCH) Service Data Unit (SDU) included in a MSGA of the random access procedure.

10. The method of claim 1, wherein the random access procedure is completed when the UE receives a MAC PDU containing a UE CRI MAC Control Element (CE), wherein a UE CRI in the UE CRI MAC CE matches a CCCH SDU transmitted in Msg3 of the random access procedure.

11. A User Equipment (UE), comprising:
a processor;
a memory operatively coupled to the processor, wherein the processor is configured to execute a program code to:
start a timer upon initiation of a Radio Resource Control (RRC) connection resume procedure, wherein the timer is used to control duration of the RRC connection resume procedure;
restart the timer upon completion of a random access procedure during the RRC connection resume procedure; and
stop the timer upon reception of a RRC response message for the RRC connection resume procedure.

12. The UE of claim 11, wherein the RRC connection resume procedure is used for small data transmission.

13. The UE of claim 11, wherein the UE goes to RRC_IDLE if the timer expires.

14. The UE of claim 11, wherein the RRC response message is a RRC release message.

15. The UE of claim 11, wherein a configuration of the timer is included in a dedicated signalling.

16. The UE of claim 11, wherein the UE receives the RRC response message after the completion of the random access procedure.

17. The UE of claim 11, wherein the UE transmits a RRC resume request message for the RRC connection resume procedure.

18. The UE of claim 11, wherein the UE is in RRC_INACTIVE when performing the RRC connection resume procedure.

19. The UE of claim 11, wherein the random access procedure is completed when the UE receives a MSGB containing a success Random Access Response (successRAR) Medium Access Control (MAC) subProtocol Data Unit (subPDU), wherein a UE Contention Resolution Identity (CRI) in the successRAR MAC subPDU matches a Common Control Channel (CCCH) Service Data Unit (SDU) included in a MSGA of the random access procedure.

20. The UE of claim 11, wherein the random access procedure is completed when the UE receives a MAC PDU containing a UE CRI MAC Control Element (CE), wherein a UE CRI in the UE CRI MAC CE matches a CCCH SDU transmitted in Msg3 of the random access procedure.
